(19) United States
(12) Patent Application Publication
(10) Pub. No.: US 2007/0252069 A1
(43) Pub. Date: Nov. 1, 2007

(54) Torque limiter, image reading apparatus and multi-function machine

(75) Inventor: Satoshi Oguchi, Matsumoto-shi (JP)

Correspondence Address: EDWARDS ANGELL PALMER & DODGE LLP, P.O. BOX 55874, BOSTON, MA, 02205, US

(73) Assignee: Seiko Epson Corporation, Tokyo (JP)

(21) Appl. No.: 11/732,342

(22) Filed: Apr. 3, 2007

(30) Foreign Application Priority Data
Apr. 3, 2006 (JP) 2006-101684
May 25, 2006 (JP) 2006-145231

(51) Int. Cl. A47B 97/04; F16D 7/02

(52) U.S. Cl. 248/458

(57) ABSTRACT

A torque limiter includes: a rotation shaft, a location of which is fixed; two rotating members, rotatable around an axis of the rotation shaft; two torsion coil springs which are wound on the rotating members, respectively; and a rotation inducing member, adapted to hold one end of each of the two torsion coil springs.

### BACKGROUND

1. Technical Field

The present invention relates to a torque limiter, an image reading apparatus, and a multi-function machine.

2. Related Art

There is a related torque limiter for preventing a damage of an apparatus having a power supply system for supplying a driving force from a driving source by interrupting a supply of an excessive load between two mechanical elements of the power supply system so as to protect the power supply system. For example, a related torque limiter of a power supply system including a gear train interrupts the supply of an excessive load by idling any one gear when being supplied with the excessive load.

In the above-mentioned power supply system, in order to interrupt the excessive load regardless of rotation directions of a gear (directions of a torque to be supplied), the torque limiter should include two gears of a gear which is idled when the gear forwardly rotates and a gear which is idled when the gear backwardly rotates.

There is a related torque limiter in which a first torque generating section is formed by fitting an annular spring holding member mounted on a single-direction clutch mechanism to a shaft, a second torque generating section is formed by fitting a C-shaped spring to an outer circumferential surface of a clutch outer wheel and allowing a slit of the C-shaped spring to engage with a rib formed in an inner circumferential surface of an outer annular member, and necessary torques are generated by the first torque generating section at the time of a free rotation of the single-direction clutch mechanism and by the second torque generating section at the time of a lock thereof, respectively (for example, see JP-A-2004-308881).

While, there is a related image reading apparatus for reading images of reflective and transmissive documents by the use of the same reading mechanism, in which a reflective reading mechanism for optically reading a document image by detecting intensity of light, which is emitted to a document table for holding a document from the same side as an image capturing device and reflected by the document, is provided and a reflecting plate for reflecting the light emitted from a light source is disposed on the opposite side of the light source about the document (for example, see JP-A-6-178059).

There is a related image reading apparatus which has a light source and an image capturing device disposed to face each other with a document table interposed therebetween and reads a document by allowing the image capturing device to receive light emitted from the light source. An emission region having such an enough area to irradiate the entire document is secured in the light source of the image reading apparatus.

As such an image reading apparatus, there is an image reading apparatus having a cover member for fixing a document to a document table and preventing unnecessary external light from being incident on an image capturing device. In the image reading apparatus having the cover member, a light source might be disposed in the cover member. A fluorescent tube or LEDs are used as a light source.

However, in the power supply system of the related art, since two gears are necessary for interrupting an excessive load regardless of the rotation directions (directions of a torque to be applied), there is a problem in that the configuration of a gear train is complicated and thus a space occupied by the power supply system is increased. The related art described in JP-A-2004-308881 has a problem in that the structure is complicated.

On the other hand, in the related art disclosed in JP-A-6-178059, the light focused on the image capturing device at the time of reading a transmissive document has passed through the transmissive document twice. Accordingly, since image data including document images overlapped with each other due to a difference corresponding to the thickness of the document are created, precision of the image data obtained by reproducing the document is lower than that of the original document.

On the contrary, as described above, in the image reading apparatus including the light source and the image capturing device disposed to face each other with the document table interposed therebetween, the reading of a document can be performed with high precision, but the following problems are caused depending on the types of light sources used therein.

When a fluorescent tube is used as the light source, there is a problem in that much time is required from a time when lighting the light source to a time when the light intensity is stabilized to such an enough level to perform a reading operation. When an emission region having such an enough area to irradiate the entire document is to be secured by the use of the light source employing the fluorescent tube, the light source increases in size and the image reading apparatus also increases accordingly in size with the increase in size of the light source.

When an LED is used as the light source, it is possible to carry out the operation of reading a document just after lighting the light source and it is also possible to reduce an occurrence of a noise in the image data, compared with the case where the fluorescent tube is used as the light source. However, since an emission area of one LED is limited, a plurality of LEDs should be provided to secure an emission region having such an enough area to irradiate the entire document. Accordingly, the light source increases in size and the image reading apparatus also increases accordingly in size with the increase in size of the light source. When a single light source includes a plurality of LEDs, there is a problem in that quality of image data deteriorates due to irregular light intensity by each of the LEDs.

As described above, in the image reading apparatus in which the light source is disposed in the cover member, when any of the fluorescent tube and the LED is used, the cover member increases in size with the increase of the light source. Accordingly, there is a problem in which an operation of moving the cover member to set a document is troublesome.

### SUMMARY

An advantage of some aspects of the invention is to provide a torque limiter which has a simple configuration and can accomplish a decrease in size and an image reading apparatus which can perform an operation of reading a document with high precision and can accomplish a decrease in size and a decrease in power consumption.

According to an aspect of the invention, there is provided a torque limiter comprising: a rotation shaft, a location of which is fixed; two rotating members, rotatable around an axis of the rotation shaft; two torsion coil springs which are wound on the rotating members, respectively; and a rotation inducing member, adapted to hold one end of each of the two torsion coil springs.

With this configuration, when a load for rotating one rotating member of two rotating members is supplied to the corresponding rotating member, the other rotating member rotates through the torsion coil spring wound on the one rotating member, the rotation inducing member, and the torsion coil spring wound on the other rotating member.

When an excessive load is supplied to one rotating member, the inner diameter of the torsion coil spring wound on one rotating member of two rotating members is enlarged to cause a slide between the torsion coil spring the inner diameter of which is enlarged and the rotating member on which the corresponding torsion coil spring is wound, thereby interrupting the supply of the excessive load.

Therefore, it is possible to simplify the configuration and decrease the size by allowing two rotating members for interrupting the supply of the excessive load to rotate around a single rotation shaft. Accordingly, a user can accomplish the decrease in size of the apparatus employing the torque limiter by reducing the space occupied by the torque limiter.

Winding directions of the two torsion coil springs may be different from each other.

In this case, it is possible to assemble the torque limiter by sequentially attaching two torsion coil springs having different winding directions to the rotation shaft. Therefore, the torque limiter can facilitate an assembly work and reduce an error of the assembly work, in addition to the simplification in configuration and the decrease in size. As a result, a user can facilitate the assembly work of the apparatus with a reduced size and reduce the error of the assembly work by employing the torque limiter.

Winding directions of the two torsion coil springs may be identical with each other.

In this case, it is possible to reduce the number of components by using two torsion coil springs having the same winding direction. Therefore, the torque limiter can reduce an error of an assembly work and reduce cost for manufacturing the apparatus, in addition to the simplification in configuration and the decrease in size. As a result, a user can reduce the cost for manufacturing the apparatus with a reduced size and reduce the error of the assembly work thereof by employing the torque limiter.

According to another aspect of the invention, there is provided an image reading apparatus which has a light source disposed in a cover member detachably attached to a document table for holding a document and an image capturing device disposed opposite to the light source with the document table interposed therebetween, the image reading apparatus comprising: a light source moving mechanism, disposed in the cover member and operable to move the light source in a scanning direction; an image capturing device moving mechanism, operable to move the image capturing device in the scanning direction; a driving source, operable to supply a driving force to the image capturing device moving mechanism; and an interlocking mechanism, operable to interlock the image capturing device moving mechanism with the light source moving mechanism through the above-mentioned torque limiter.

With this configuration, by connecting the light source moving mechanism to the image capturing device moving mechanism through the interlocking mechanism, it is possible to interlock the light source with the image capturing device by the use of the same driving source, thereby preventing relative position in a sub scanning direction between the light source and the image capturing device from getting different from each other at the time of movement.

Here, loads required for moving the image capturing device and the light source are different from each other. Accordingly, when the driving force of the same driving source is supplied directly to the image capturing device and the light source, an excessive driving force may be supplied to one having the smaller load required for movement out of the image capturing device and the light source. For this reason, the torque limiter for suppressing the excessive driving force is inevitable in the image reading apparatus. On the other hand, since a decrease in size was recently required for a variety of electronic products including an image reading apparatus, it is necessary to avoid an increase in size of the image reading apparatus due to addition of the torque limiter.

Accordingly, since the image reading apparatus uses the torque limiter, it is possible to interlock the image capturing device and the light source requiring the different loads for movement thereof with high precision by the use of the driving force of the same driving source. As a result, according to the image reading apparatus, it is possible to prevent decrease in precision for reading a document due to the difference in relative position in the sub scanning direction between the light source and the image capturing device at the time of movement and it is also possible to accomplish a decrease in size of the image reading apparatus and a decrease in power consumption of the image reading apparatus. Therefore, a user can obtain image data which are reproduced from an image of a document with high precision by the use of a small-sized image reading apparatus with reduced power consumption.

According to another aspect of the invention, there is provided an image reading apparatus which has a light source disposed in a cover member detachably attached to a document table for holding a document and an image capturing device disposed opposite to the light source with the document table interposed therebetween, the image reading apparatus comprising: a light source moving mechanism, disposed in the cover member and operable to move the light source in a scanning direction; an image capturing device moving mechanism, operable to move the image capturing device in the scanning direction; a driving source, operable to supply a driving force to the image capturing device moving mechanism; and an interlocking mechanism, operable to interlock the image capturing device moving mechanism with the light source moving mechanism by allowing an attractive force to act between the light source moving mechanism and the image capturing device moving mechanism depending on a position of the cover member relative to the document table.

With this configuration, it is possible to interlock the light source moving mechanism with the image capturing device moving mechanism by connecting the light source moving mechanism to the image capturing device moving mechanism by the use of the attractive force acting between the light source moving mechanism and the image capturing device moving mechanism depending on the attachment or detachment of the cover member. Therefore, the image reading apparatus can accomplish a decrease in size of the image reading apparatus due to the sharing of the driving source and a decrease in power consumption due to the sharing of the driving source. Accordingly, a user can easily interlock the light source moving mechanism with the image capturing device moving mechanism and thus interlock the light source with the image capturing device by performing only an operation of attaching and detaching the cover member to and from the document table, thereby obtaining image data with high precision.

The interlocking mechanism may apply an attractive force having a magnitude enough to cause a slide between the light source moving mechanism and the image capturing device moving mechanism when a torque having a predetermined value or more is supplied to the interlocking mechanism.

For example, the predetermined value is set to a value which is required for allowing the light source moving mechanism to move the light source and which causes no damage on the constituent elements of the light source moving mechanism.

Therefore, it is possible to supply a torque from the image capturing device moving mechanism to the light source moving mechanism as long as the torque is less than the predetermined value. Accordingly, in the light source and the image capturing device which move with the driving force from the same driving source, when a load required for the movement of the light source is less than a load required for the movement of the image capturing device due to a decrease in weight accompanied with the decrease in size, it is possible to interlock the image capturing device moving mechanism with the light source moving mechanism without causing damage on the light source or the light source moving mechanism. As a result, a user can acquire image data with high precision by interlocking the image capturing device moving mechanism with the light source moving mechanism without feeling a particular burden.

The image reading apparatus may further comprise a hinge portion, rotatably connecting one end of the cover member to a main body housing for housing the image capturing device. The cover member may rotate about the main body housing through the hinge portion so as to be attached to and detached from the document table.

In this case, it is possible to freely connect the light source moving mechanism to the image capturing device moving mechanism by allowing the cover member to rotate about the hinge portion. Therefore, since the cover member can be allowed to rotate about the hinge portion by the use of a leverage principle, it is possible to reduce a user's burden at the time of attaching and detaching the cover member to and from the document table. Accordingly, the user can obtain image data with high precision by easily attaching and detaching the cover member to and from the document table.

The driving source may be disposed in the main body housing.

In this case, it is possible to reduce the weight of the cover member. Therefore, the image reading apparatus can reduce a user's burden accompanied with the rotation of the cover member. Accordingly, the user can obtain image data with high precision by rotating the cover member with a small burden to interlock the light source moving mechanism with the image capturing device moving mechanism.

The driving source maybe disposed in the cover member.

In this case, it is possible to simplify the image capturing device moving mechanism in the main body housing. Therefore, it is possible to prevent a damage of the image reading apparatus due to the heat radiation resulting from the excessive density in the main body housing. Accordingly, a user can use safely a small-sized multi-function machine with reduced power consumption and can obtain image data with high precision by only attaching and detaching the cover member to and from the document table.

The light source may include an LED.

In this case, it is possible to read a document just after lighting the light source and to stabilize the light intensity, compared with a case where a fluorescent tube is used instead of the LED. Therefore,the image reading apparatus can rapidly start the operation of reading a document and accomplish an enhancement in reading precision. Accordingly, a user can rapidly obtain image data with high precision for the minimum time.

In addition, it is possible to suppress the power consumption by using the LED and thus to suppress running cost, compared with a case where a fluorescent tube is used instead of the LED. Accordingly, a user can rapidly obtain image data with high precision by using the image reading apparatus with reduced power consumption and running cost.

According to another aspect of the invention, there is provided a multi-function machine comprising: the above-mentioned image reading apparatus; and an image forming apparatus, operable to form on a recording medium an image corresponding to intensity of light incident on the image capturing device of the image reading apparatus.

With this configuration, it is possible to accomplish a decrease in power consumption at the time of reading a document and a decrease in size of the multi-function machine, by using the image data read by the image reading apparatus. Therefore, the multi-function machine can form an image, which is reproduced from the document with high precision, on a recording medium while suppressing an increase in power consumption and an increase in size of the multi-function machine. Accordingly, a user can obtain image data with high precision by the use of the multi-function machine with reduced power consumption.

Furthermore, it is possible to interlock the light source moving mechanism with the image capturing device moving mechanism depending on the attachment or detachment of the cover member in the image reading apparatus. Therefore, the multi-function machine can accomplish a decrease in size of the multi-function machine due to the sharing of the driving source and a decrease in power consumption due to the sharing of the driving source. Accordingly, a user can obtain image data with high precision by performing only an operation of attaching and detaching the cover member to and from the document table, by the use of a small-sized multi-function machine with reduced power consumption.

The present disclosure relates to the subject matter contained in Japanese patent application Nos. 2006-101684 filed on Apr. 3, 2006 and 2006-145231 filed on May 25,2006, which are expressly incorporated herein by reference in its entirety.

### BRIEF DESCRIPTION OF THE DRAWINGS

The invention will be described with reference to the accompanying drawings, wherein like numbers reference like elements.

FIG. 1 is a perspective view illustrating an appearance of a scanner according to a first embodiment of the invention.

FIG. 2 is a longitudinal-section front view of the scanner.

FIG. 3 is a partially sectional perspective view of the scanner.

FIG. 4 is an exploded perspective view of a transmissive light source unit.

FIG. 5 is an enlarged perspective view (first) illustrating an interlocking mechanism according to the first embodiment.

FIG. 6 is an enlarged perspective view (second) illustrating the interlocking mechanism according to the first embodiment.

FIG. 7 is a side view illustrating an appearance of a torque limiter.

FIG. 8 is a cross-sectional view taken along line X-X of FIG. 7.

FIG. 9 is a side view illustrating an appearance of a torque limiter according to a second embodiment of the invention.

FIG. 10 is a cross-sectional view taken along line X-x of FIG. 9.

FIG. 11 is a partially sectional perspective view of a scanner according to a third embodiment of the invention.

FIG. 12 is an enlarged perspective view (first) of an interlocking mechanism according to a third embodiment of the invention.

FIG. 13 is an enlarged perspective view (second) of the interlocking mechanism according to the third embodiment.

FIG. 14 is a perspective view illustrating a multi-function machine according to a fourth embodiment of the invention.

### DESCRIPTION OF EXEMPLARY EMBODIMENTS

### First Embodiment

Hereinafter, a torque limiter and an image reading apparatus according to a first embodiment of the invention will be described in detail with reference to the accompanying drawings. The first embodiment relates to a torque limiter and a scanner in which the torque limiter and the image reading apparatus according to the invention are embodied.

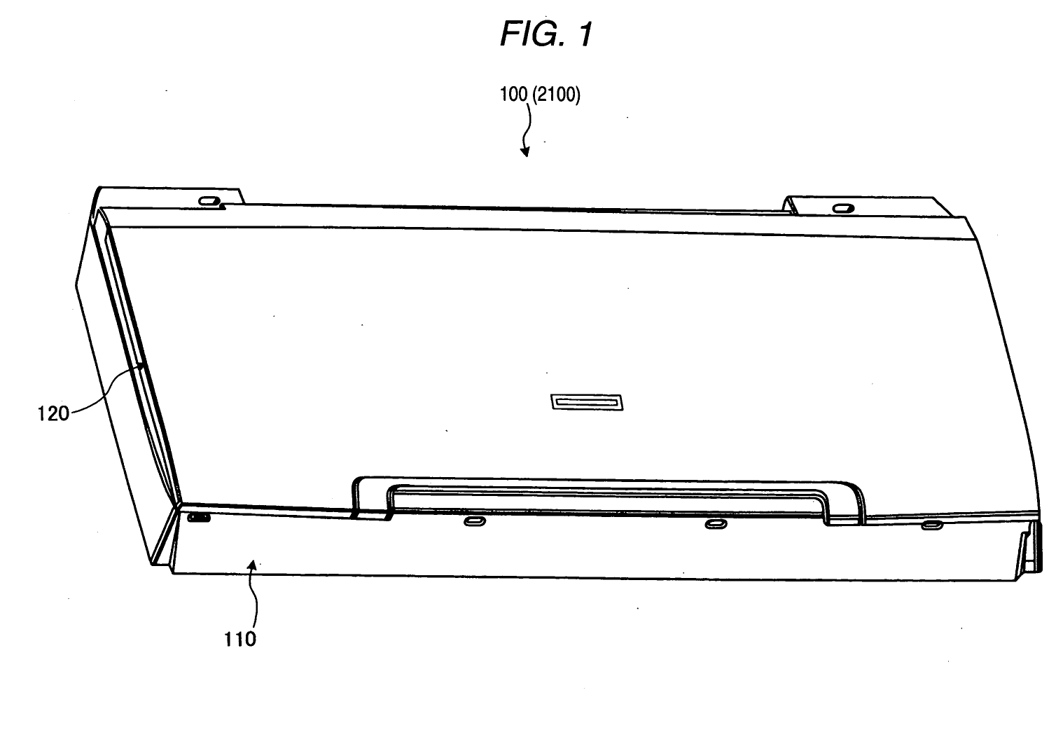

FIG. 1 is a perspective view illustrating an appearance of a scanner according to the first embodiment of the invention. The appearance of the scanner according to the first embodiment will be first described with reference to FIG. 1. As shown in FIG. 1, the scanner 100 includes a main body unit 110 and a transmissive-document light source unit (hereinafter, referred to as “TPU unit”) 120. In the first embodiment, a cover member is embodied by the TPU unit 120.

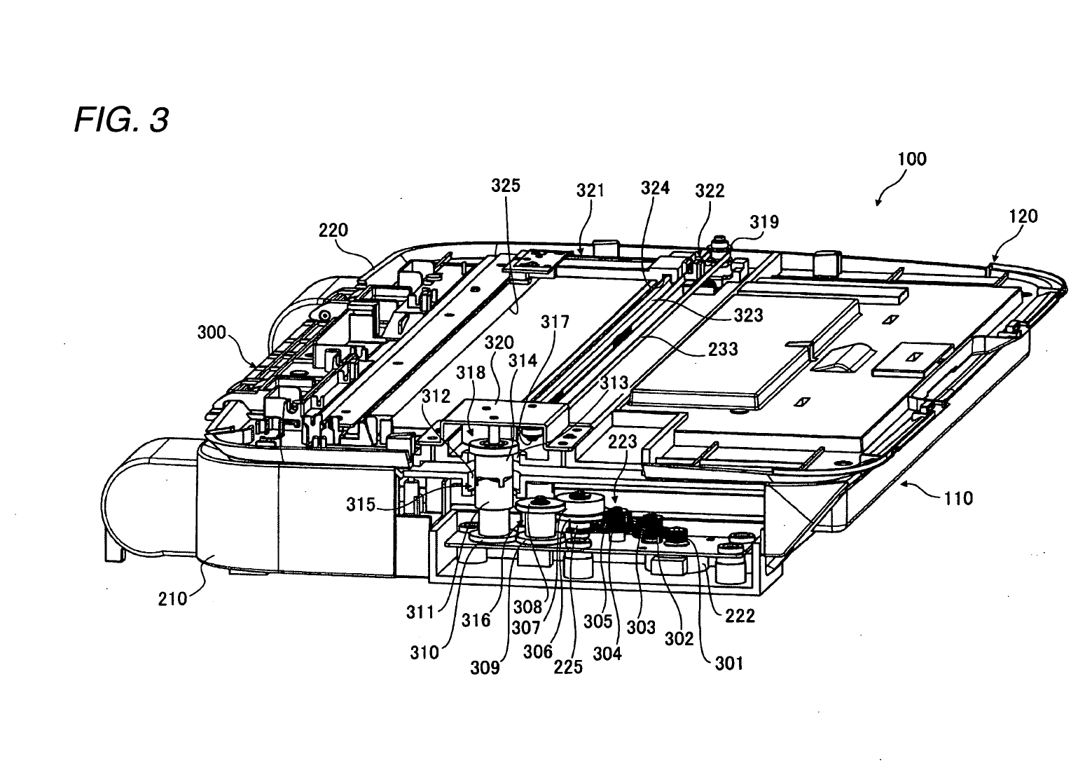

The TPU unit 120 is disposed opposite to the main body unit 110 and is connected to the main body unit 110 through a hinge portion (see FIG. 3). The TPU unit 120 can rotate about the hinge portion in a direction getting away from the main body unit 110 from the state shown in FIG. 1.

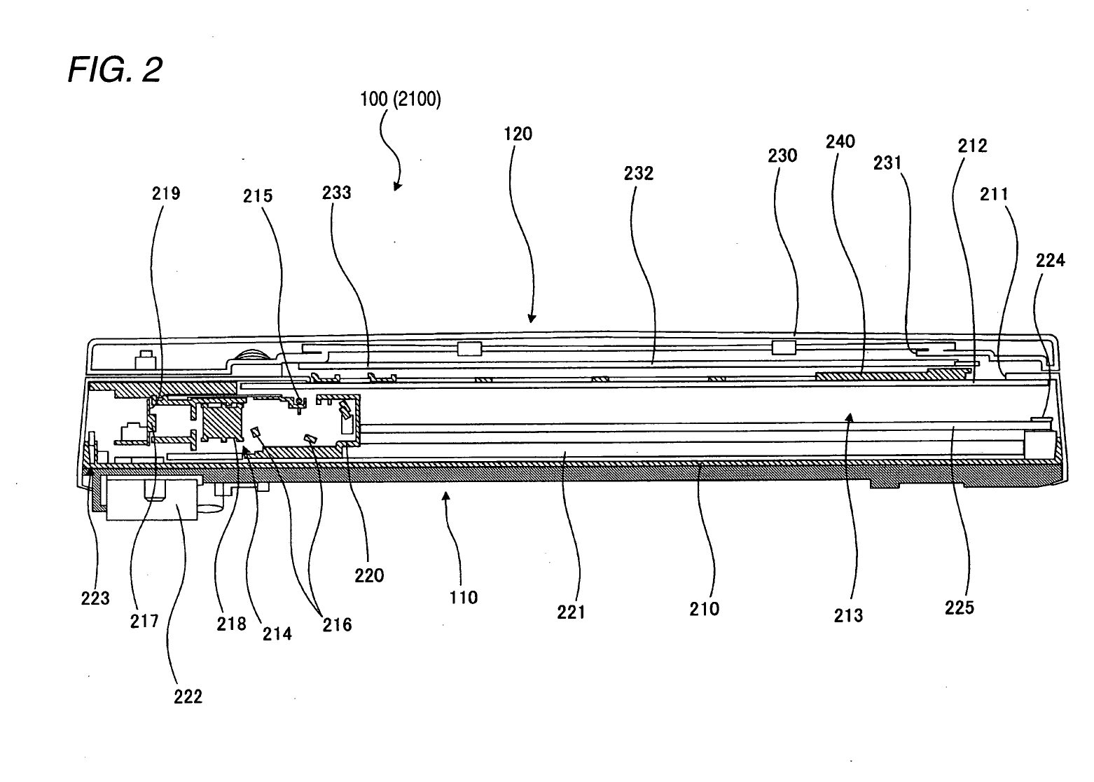

FIG. 2 is a longitudinal-section front view of the scanner 100 according to the first embodiment. A rough configuration of the scanner 100 according to the first embodiment will be next described with reference to FIG. 2. As shown in FIG. 2, the scanner 100 includes a main body housing 210 constituting the outline of the main body unit 110 and a TPU housing 230 constituting the outline of the TPU unit 120.

Each of the main body housing 210 and the TPU housing 230 includes two parts which can be separated vertically. Particular reference numerals are omitted, but the parts constituting the upper portions of the main body housing 210 and the TPU housing 230 are referred to as an upper main body housing and an upper TPU housing, respectively similarly, the parts constituting the lower portions of the main body housing 210 and the TPU housing 230 are referred to as a lower main body housing and a lower TPU housing, respectively.

A schematic configuration of the main body unit 110 is first described. The main body housing 210 of the main body unit 110 includes an opening 211 opened to the PUT housing 230. The opening 211 is provided with a document table glass 212 as a document table so as to cover the opening 211.

In the first embodiment, a reading window is constituted by the opening 211 and the document table glass 212, and a frame member is constituted by a peripheral portion of the opening 211 of the main body housing 210. A document to be read is placed on the document table glass 212.

An optical member 214 for optically reading an image of the document placed on the document table glass 212 is provided in a space 213 formed by the main body housing 210 and the document table glass 212. The optical member 214 includes a reflective light source 215 for emitting light to the document table glass 212, a plurality of mirrors 216 for guiding the light, which is emitted from the reflective light source 215 and reflected by the document, to a predetermined path, an image capturing device 217 for receiving the light guided by the mirrors 216, and a lens 218 for focusing the light guided by the mirrors 216 on the image capturing device 217.

Photodiodes which convert an optical image focused on a light-receiving face into electrical signals corresponding to the light intensity received by each element and output the electrical signals can be used as the image capturing device 217. In the scanner 100, a linear image sensor in which the photodiodes are linearly arranged in a main scanning direction on a scanning circuit board 219 is used as the image capturing device 217.

A scanner carriage 220 is also disposed in the space 213. The scanner carriage 220 is slidable along a carriage guide 221 which is parallel to the document table glass 212 and which extends in a sub scanning direction.

A driving force generated from a motor 222 as a driving source is supplied to the scanner carriage 220 through an image capturing device moving mechanism 223 connected to the motor 222 as the driving source. As described later, the image capturing device moving mechanism 223 includes a gear train connected to a drive shaft of the motor 222 and a drive belt 225 disposed between gears of the gear train and a gear follower 224 (see FIG. 3). The scanner carriage 220 is connected to the drive belt 225.

The scanner carriage 220 moves in the sub scanning direction along the document table glass 212 with a supply of a driving force generated from the motor 222 through the image capturing device moving mechanism 223. The scanner carriage 220 moves between a home position which is set at an end position where the reading of a document is started and a return position which is set at a position where the document having been read is returned to the home position.

The optical member 214 is mounted on the scanner carriage 220. The optical member 214 moves in the sub scanning direction along the document table glass 212 with the movement of the scanner carriage 220.

Next, a schematic configuration of the TPU unit 120 will be described. The TPU housing 230 of the TPU unit 120 is provided with an opening 231 opened to the main body housing 210 so as to face the main body housing 210. A protective mat 232 is disposed to cover the opening 231 of the TPU housing 230. The protective mat is detachable from the TPU housing 230.

The TPU housing 230 is provided with a transmissive light source unit (see FIG. 3) as a transmissive-document light source. The transmissive light source unit is used to read a light-transmitting document such as a photograph film and emits light toward the document table glass 212. The transmissive light source unit is movable in the sub scanning direction along the document table glass 212.

The TPU housing 230 is provided with a power supply mechanism (see FIG. 3) as a light source moving mechanism for supplying the driving force of the motor 222 to the transmissive light source unit. Although not shown and described in detail, the power supply mechanism disposed in the TPU unit 120 includes, for example, a pulley group connected to the image capturing device moving mechanism 223, a drive belt 233, and a pair of gear on which the drive belt 233 is suspended (partially see FIG. 3).

In the first embodiment, the power supply mechanism disposed in the TPU housing 230 is connected to the motor 222 to supply the driving force of the motor 222 to the transmissive light source unit when the protective mat 232 is detached from the TPU housing 230. In this case, only when the protective mat 232 is detached from the TPU housing 230, the transmissive light source unit moves in the sub scanning direction along with the scanner carriage 220 by means of the driving force supplied from the motor 222.

The transmissive light source unit moves between a home position which is set at an end position where the reading of a document is started and a return position which is set at a position where the document having been read is returned to the home position.

At the time of reading a light-transmitting document (hereinafter, referred to as “film”) such as a film, a film holder 240 is disposed on the document table glass 212, that is, between the main body unit 110 and the TPU unit 120. The film holder 240 is a member for guiding the film so as to be located at a reading position of a film on the document table glass 212 and fixing the film to the reading position.

FIG. 3 is a partially sectional perspective view of the scanner 100 according to the first embodiment. FIG. 3 shows a state where the upper TPU housing of the TPU housing 230 is removed and a part of the main body housing 210 is cut out. In FIG. 3, reference numeral 300 denotes a hinge portion for connecting the main body unit 110 and the TPU unit 120 to each other. Now, respective units supplied with the driving force of the motor 222 are described with reference to FIG. 3.

As shown in FIG. 3, an image capturing device moving mechanism 223 disposed in the main body housing 210 includes a gear 301 fixed to a drive shaft of a motor 222 and a gear train 302 to 306 connected to the gear 301. A gear on which the drive belt 225 is suspended is disposed on a shaft which is a rotation axis of the gear 306.

The image capturing device moving mechanism 223 allows the drive belt 225 to rotate by supplying the driving force generated from the motor 222 to the drive belt 225 through the gears 301 to 306. Accordingly, the scanner carriage 220 connected to the drive belt 225 can move in the sub scanning direction.

The shaft as a rotation axis of the gear 306 is provided with a pulley 307 using the shaft as a rotation axis. A gear 311 is connected to the pulley 307 through a plurality of pulleys 308 to 310 rotating with the rotation of the pulley 307. The gear 311 detachably engages with a gear 314 disposed on the TPU unit 120 side through openings 312 and 313 opened toward the TPU unit 120 on the top surface of the main body housing 210.

The gear 311 rotates around an axis parallel to the axial direction of the pulleys 308 to 310 by receiving the driving force of the motor 222 through the pulleys 308 to 310. The gear 314 is disposed to be rotatable around the axis parallel to the axial direction of the gear 311 and rotates in the same direction with the rotation of the gear 311. Here, the pulleys 307 to 310, the gear 311, the openings 312 and 313, and the gear 314 constitute an interlocking mechanism 315.

The pulleys 308 and 309 constituting a part of the interlocking mechanism 315 rotate around the same axis. In the first embodiment, two rotating members are embodied as the pulleys 308 and 309. The pulleys 308 and 309 constitute a part of a torque limiter 316. In the torque limiter 316, the pulley 308 is connected to the pulley 307 and the pulley 309 is connected to the pulley 310 rotating around the same axis as the gear 311.

Although the detailed structure is described later, the torque limiter 316 has a torque limiter function of interrupting a torque having a magnitude equal to or larger than a predetermined value so as not to supply the torque to the power supply mechanism through the pulley 310 when the torque supplied from the image capturing device moving mechanism 223 through the pulley 307.

Here, the torque having the predetermined magnitude is a torque required for moving the transmissive light source unit. Even when the torque having a magnitude equal to or larger than the predetermined magnitude is supplied from the image capturing device moving mechanism 223, it is possible to prevent the power supply mechanism and the transmissive light source unit from being damaged thanks to the torque limiter 316.

The TPU housing 230 is provided with a pulley group 318 for connecting one gear 317 of the pair of gears, which the drive belt 233 is suspended on, to the gear 314, The other gear 319 of the pair of gears rotates with the rotation of the drive belt 233. The gear 317 and the gear 319 are disposed opposite to each other in the sub scanning direction. Here, a power supply mechanism as the light source moving mechanism is constituted by the drive belt 233, the gears 317 and 319.

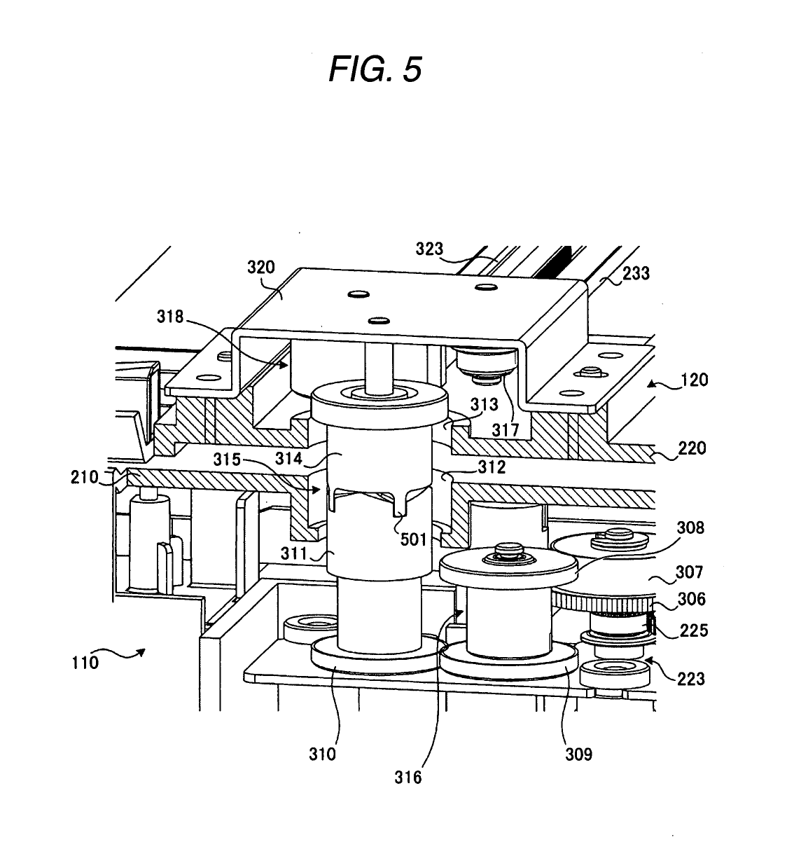

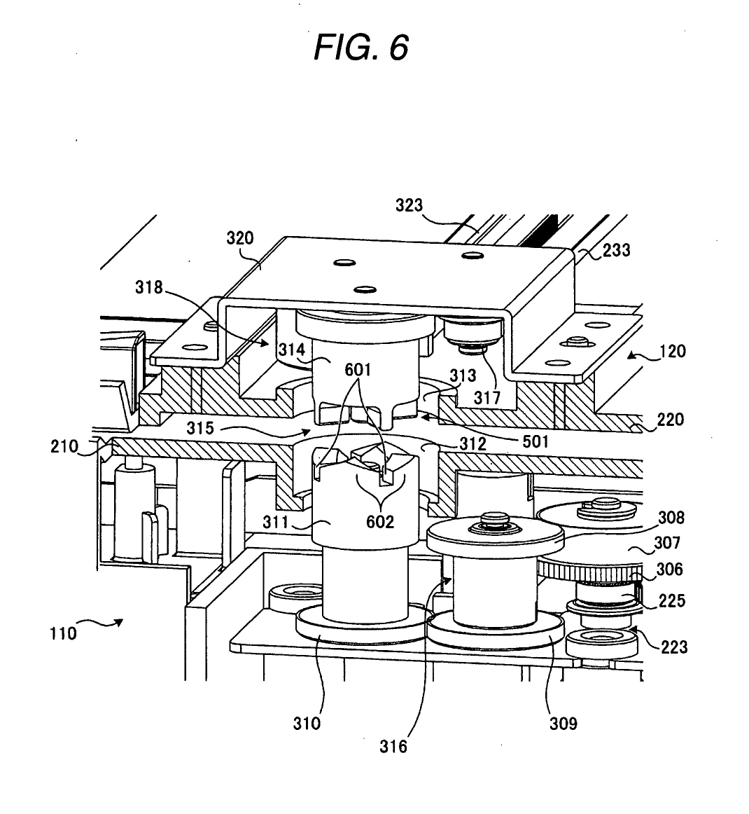

In FIG. 3, reference numeral 320 denotes a stay for supporting shafts of the gear 314, the gear 317, the pulleys of the pulley group 318, and the like. The gear 314 is disposed to be detachable from the stay 320 (see FIGS. 5 and 6). As a result, the gear 311 and the gear 314 can be allowed to detachably engage with each other.

In FIG. 3, reference numeral 321 denotes the transmissive light source unit. The transmissive light source unit 321 is connected to the drive belt 233 at a fixing portion 322 disposed in the transmissive light source unit 321. Accordingly, the transmissive light source unit 321 moves in the sub scanning direction with the rotation of the drive belt 233.

The TPU housing 230 is provided with a guide rail 323 extending in the sub scanning direction at a position which is a side of the drive belt 233 and which is overlapped with the movement trace of the transmissive light source unit 321. The guide rail 323 is inserted into a groove 324 disposed at a position opposed to the guide rail 323 in the transmissive light source unit 321. Accordingly, the transmissive light source unit 321 can stably move in the sub scanning direction.

The light emitted from the transmissive light source unit 321 is guided to the document table glass 212 through an opening 325 formed in the TPU housing 230. The opening 325 is disposed to cover a film reading range of a region which can be irradiated by the transmissive light source unit 321.

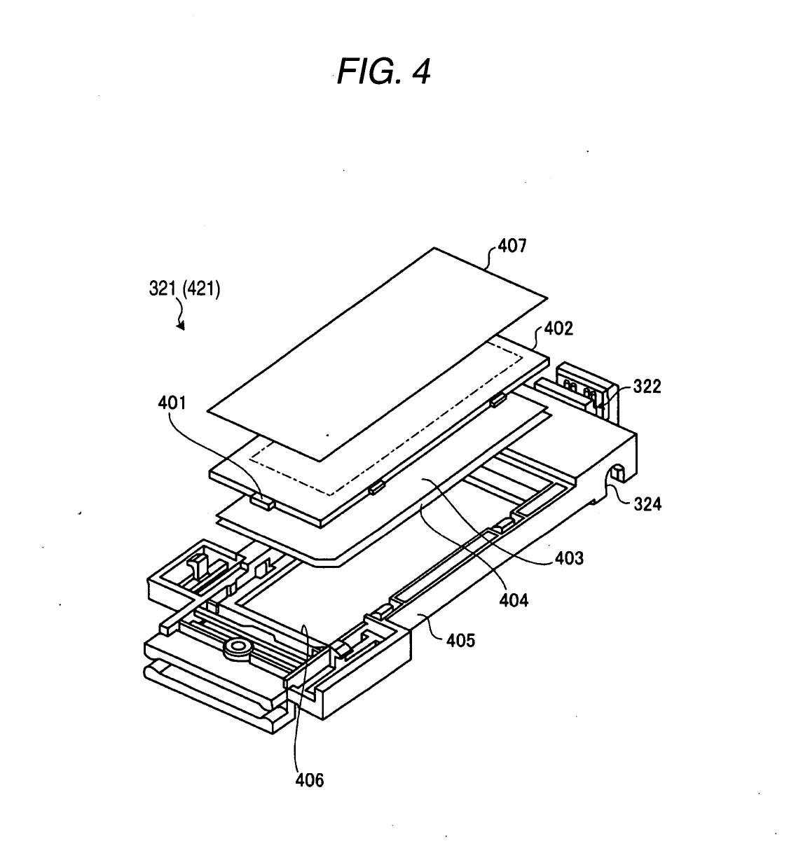

FIG. 4 is an exploded perspective view illustrating the transmissive light source unit 321. Next, a configuration of the transmissive light source unit 321 will be described with reference to FIG. 4. As shown in FIG. 4, the transmissive light source unit 321 includes LEDs 401 and a light guide plate 402 for guiding the light emitted from the LEDs 401. An area larger than an irradiating area of one LED can be irradiated by the light guide plate 402. In FIG. 4, a virtual line marked on the light guide plate 402 indicates an effective emission area of the light guide plate 402.

The light guided by the light guide plate 402 is made to travel from the opening 406 disposed in the support frame 405 to the document table glass 212 through a diffusion sheet 403 and a prism sheet 404. By employing the prism sheet 404 and the diffusion sheet 403, the light guided by the light guide plate 402 can be more uniformly radiated in a larger area.

In the transmissive light source unit 321, a reflecting plate 407 for reflecting the light guided by the light guide plate 402 toward the opening 406 is disposed on the side opposite to the opening 406 with the light guide plate 402 interposed therebetween. By providing the reflecting plate 407, the light guided by the light guide plate 402 can be efficiently radiated toward the document table glass 212. A fixing portion 322 is disposed on a side of the support frame 405 and is opened upward so as to press the drive belt 233 from the document table glass 212 side.

FIG. 5 is an enlarged perspective view (first) of an interlocking mechanism 315 and FIG. 6 is an enlarged perspective (second) of the interlocking mechanism 315. FIG. 5 shows a state where the gear 311 and the gear 314 engage with each other. FIG. 6 shows a state where the gear 311 and the gear 314 disengage from each other. As can be seen from FIGS. 5 and 6, the gear 314 of the interlocking mechanism 315 is connected to the gear 311 when it is apart from the stay 320 and is disconnected from the gear 311 when it is located in the vicinity of the stay 320.

As can be seen from FIGS. 5 and 6, the gear 314 of the interlocking mechanism 315 is provided with gear teeth 501 protruding toward the TPU unit 110 concave portions 601 engaging with the gear teeth 501 are formed in the gear 311 of the interlocking mechanism 315. The top portions of ribs 602 which are located between the concave portions 601 to form the concave portions 601 are formed in a mountain shape of which the centers protrude toward the gear 313 as it goes toward the center thereof. Accordingly, the gear teeth 501 can be guided to the concave portions 601 so as to allow the gear 311 and the gear 314 to engage with each other.

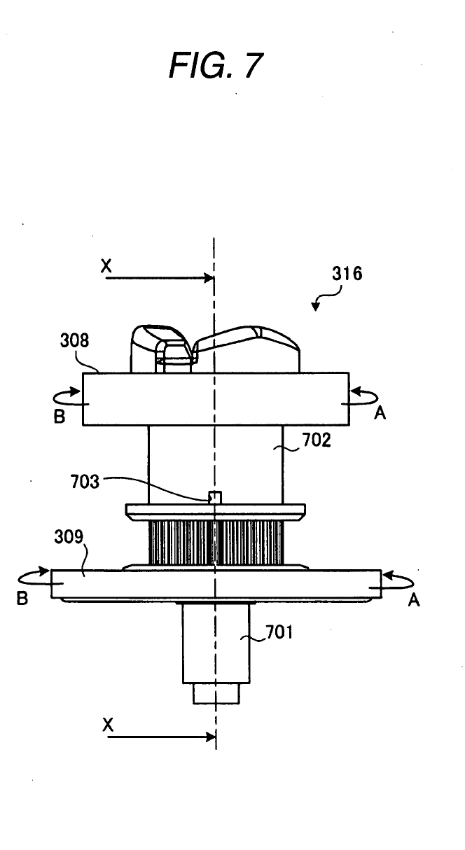

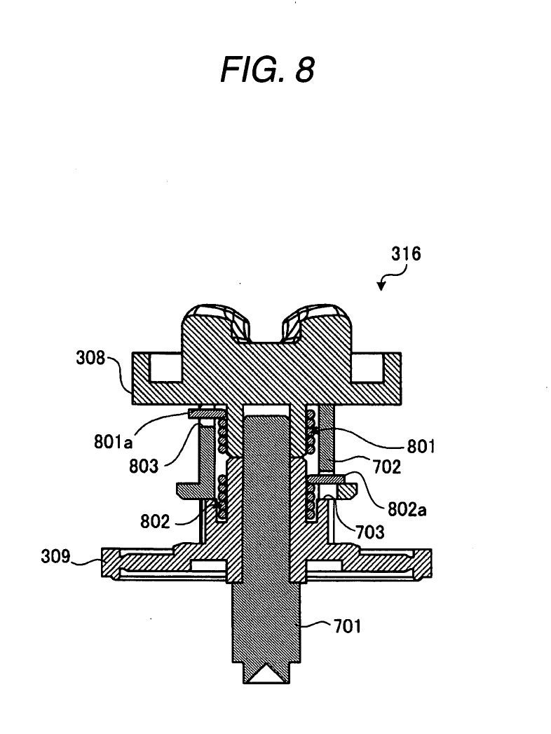

FIG. 7 is a side view illustrating an appearance of the torque limiter 316 and FIG. 8 is a cross-sectional view taken along line X-X of FIG. 7. The torque limiter 316 will be described in detail with reference to FIGS. 7 and 8. As shown in FIG. 7, pulleys 308 and 309 disposed in the torque limiter 316 are rotatable around a rotation shaft 701 which is centered on a virtual line of FIG. 7. The pulleys 308 and 309 are rotatable in any direction of a direction indicated by arrow A and a direction indicated by arrow B in FIG. 7.

As shown in FIG. 7, an O ring 702 as a rotation inducing member is disposed between the pulley 309 and the pulley 308 along the axial direction of the rotation shaft 701. The O ring 702 is provided with two openings for holding an arm of two torsion coil springs (see FIG. 8). In FIG. 7, reference numeral 703 denotes an opening for holding the arm of one torsion coil spring of two torsion coil springs.

As shown in FIG. 8, the pulleys 308 and 309 in the torque limiter 316 are provided with two torsion coil springs 801 and 802, respectively. The torsion coil springs 801 and 802 nip and retain parts of the pulleys 308 and 309 along with the rotation shaft 701, respectively. The torsion coil springs 801 and 802 have winding directions different from each other.

The inner diameters of the torsion coil springs 801 and 802 are set equal to or less than the outer diameters of the pulleys 308 and 309 sandwiched by the torsion coil springs 801 and 802. Accordingly, the torsion coil springs 801 and 802 rotate with the rotations of the pulleys 308 and 309, respectively. The outer diameter of the torsion coil springs 801 and 802 are set smaller than the inner diameter of the O ring 702.

In the torsion coil springs 801 and 802, ends located on the upper sides thereof in a state where they are disposed around the rotation shaft 701 are provided with arm portions 801a and 802a protruding in a direction which is apart from the rotation shaft 701, respectively. The arm portions 801a and 802a protrude from the openings 704 and 803 formed in the O ring 702 to the outside of the O ring 702.

Although not shown in the figures, the scanner 100 further includes an operation panel for inputting a variety of user's instructions, a variety of control circuits for controlling the constituent elements of the scanner 100, and a control system for controlling the variety of control circuits in accordance with the instructions input from the operation panel, in addition to the above-mentioned configuration. An instruction for reading an image of a document (reflective document) such as a sheet of paper not transmitting light, an instruction for reading an image of a film, and the like are input to the operation panel.

Although not shown in the figures, the scanner 100 may further include a communication I/F for performing a communication with an external device such as a personal computer In this case, the scanner 100 receives commands corresponding to instructions input to the personal computer through the communication I/F.

The scanner 100 moves the scanner carriage 220, lights/extinguishes the reflective light source 215 or the transmissive light source unit 321, or creates image data by converting the light focused on the image capturing device 217 into electrical signals, in accordance with instructions input to the operation panel or commands received through the communication I/F. In the first embodiment, a function of image data creating means is embodied by elements associated with the creating the image data and a variety of processes performed by the elements.

The scanner 100 may store the created image data in any storage medium or may transmit the created image data to an external device such as a personal computer through the communication I/F. In the first embodiment, a function of output means is embodied by elements associated with the transmission of the created image data to the external device and a variety of processes performed by the elements.

When an image of a film is read by the scanner 100 having the above-mentioned configuration, a user places a film holder 240 on the document table glass 212 and places a film at a predetermined position guided by the film holder 240. The user detaches the protective mat 232 from the TPU housing 230 before or after placing the film.

Subsequently, as shown in FIG. 1 or 2, the TPU unit 120 is opposed to the main body unit 110. Accordingly, the gear 311 and the gear 314 engage with each other by inserting the gear teeth 501 into the concave portions 601. Here, the power supply mechanism is interlocked with the image capturing device moving mechanism 223 by the interlocking mechanism 315.

Thereafter, the user inputs an instruction for reading an image of the film. The instruction may be input through the operation panel of the scanner 100 or may be input through the external device such as a personal computer.

When the instruction for reading the image of the film is input, the scanner 100 drives the motor 222 and detects the intensity of light received by the image capturing device 217 while moving the scanner carriage 220 and the transmissive light source unit 318 in the sub scanning direction. The scanner creates image data based on the detected intensity of light.

The scanner 100 may store the created image data in any storage medium or may transmit the created image data to an external device such as a personal computer through the communication I/F.

Before creating the image data, the scanner 100 may acquire a variety of reference data serving as a reference of a black color or a white color in the image data and may perform a shading correction on the image data on the basis of the acquired reference data. The acquisition of the reference data and the shading correction using the acquired reference data are not described herein.

Before creating image data, the scanner 100 may perform a correction process of correcting the relative position between the transmissive light source unit 321 and the image capturing device 217. At the time of performing the correction process, the scanner carriage 220 is allowed to reciprocate once between the home position and the return position of the scanner carriage 220, for example, by driving the motor 222 in a state where the power supply mechanism disposed in the TPU unit 120 and the image capturing device moving mechanism 223 are interlocked with each other through the interlocking mechanism 315.

At this time, since the power supply mechanism disposed in the TPU unit 120 and the image capturing device moving mechanism 223 are interlocked with each other by the interlocking mechanism 315, the transmissive light source unit 321 reciprocates with the reciprocation of the scanner carriage 220. As described above, in the scanner 100, a distance between the home position and the return position of the scanner carriage 220 is set larger than a distance between the home position and the return position of the transmissive light source unit 321.

Accordingly, the transmissive light source unit 321 reaches the return position of the transmissive light source unit 321 while the scanner carriage 220 moves from the home position to the return position. Alternatively, for the same reason, the transmissive light source unit 321 reaches the home position of the transmissive light source unit 321 while the scanner carriage 220 moves from the return position to the home position.

At the time of performing such a correction process, due to the relationship between the moving distance of the scanner carriage 220 and the moving distance of the transmissive light source unit 321, it is necessary to drive the motor 222 so as to allow the scanner carriage 220 to move even after the transmissive light source unit 321 reaches the return position or the home position of the transmissive light source unit 321.

At this time, when the driving force of the motor 222 is applied directly to the transmissive light source unit 321 which reaches the return position or the home position, the transmissive light source unit 321 or the power supply mechanism may be damaged.

On the contrary, since the scanner 100 according to the first embodiment is provided with the torque limiter 316, it is possible to prevent a torque having a magnitude larger than a predetermined magnitude from being supplied to the transmissive light source unit 321 and the power supply mechanism.

For example, when a torque for rotating the pulley 308 in a direction indicated by arrow A in FIG. 7 is supplied to the pulley 308 of the torque limiter 316, the torsion coil spring 801 rotates in the direction of arrow A in FIG. 7 with the rotation of the pulley 308 in the direction of arrow A in FIG. 7. Since the arm portion 801a of the torsion coil spring 801 is held by the opening 803, the O ring 702 rotates in the direction of arrow A in FIG. 7 with the rotation of the torsion coil spring 801.

When the O ring 702 rotates, the torsion coil spring 802 of which the arm portion 802a is held by the opening 803 rotates in the direction of A in FIG. 7 with the rotation of the O ring 702. The pulley 309 rotates in the direction of arrow A in FIG. 7 with the rotation of the torsion coil spring 802. Accordingly, the driving force of the motor 222 is supplied to the power supply mechanism through the image capturing device moving mechanism 223 and the interlocking mechanism 315.

The torsion coil spring 801 rotating with the rotation of the pulley 308 is supplied with an urging force acting in a direction in which the inner diameter (outer diameter) of the torsion coil spring 801 is enlarged from the O ring 702. When the torque supplied to the pulley 308 has a magnitude equal to or larger than a predetermined magnitude, the inner diameter (outer diameter) of the torsion coil spring 801 is enlarged to reduce a frictional force acting between the torsion coil spring 801 and the pulley 308, thereby causing a slide between the torsion coil spring 801 and the pulley 308.

In this way, when a torque having a magnitude equal to or greater than a predetermined magnitude in the direction of arrow A in FIG. 7 is supplied to the pulley 308, the torque limiter 316 can prevent the torque having a magnitude equal to or greater than a predetermined magnitude from being supplied to the transmissive light source unit 321 and the power supply mechanism.

For example, when a torque for rotating the pulley 308 in a direction indicated by arrow B in FIG. 7 is supplied to the pulley 308 of the torque limiter 316, the torsion coil spring 801, the O ring 702, the torsion coil spring 802, and the pulley 309 rotate in the direction of arrow B in FIG. 7 with the rotation of the pulley 308 in the direction of arrow B in FIG. 7. Accordingly, the driving force of the motor 222 is supplied to the power supply mechanism through the image capturing device moving mechanism 223 and the interlocking mechanism 315.

The torsion coil spring 802 rotating with the rotation of the O ring 702 is supplied with an urging force acting in a direction in which the inner diameter (outer diameter) of the torsion coil spring 802 is enlarged from the O ring 702. When the torque supplied to the pulley 308 has a magnitude equal to or larger than a predetermined magnitude, the inner diameter (outer diameter) of the torsion coil spring 802 is enlarged to reduce a frictional force acting between the torsion coil spring 802 and the pulley 309, thereby causing a slide between the torsion coil spring 802 and the pulley 309.

In this way, when a torque having a magnitude equal to or greater than a predetermined magnitude in the direction of arrow B in FIG. 7 is supplied to the pulley 308, the torque limiter 316 can prevent the torque having a magnitude equal to or greater than a predetermined magnitude from being supplied to the transmissive light source unit 321 and the power supply mechanism.

As described above, in the torque limiter 316 disposed in the scanner 100 according to the first embodiment, the pulleys 308 and 309 for causing a slide can be allowed to rotate about the single rotation shaft 701 so as to interrupt the supply of the torque having a magnitude equal to or greater than a predetermined magnitude.

Accordingly, the torque limiter 316 can obtain a simplification of a structure and a decrease in size. As a result, a user can decrease the size of the scanner 100 employing the torque limiter 316 by reducing the space occupied by the torque limiter 316.

Since two torsion coil springs 801 and 802 of the torque limiter 316 disposed in the scanner 100 according to the first embodiment have the winding directions different from each other, it is possible to assemble the torque limiter 316 by sequentially attaching the torsion coil springs 801 and 802 to the rotation shaft 701.

Accordingly, the torque limiter 316 can facilitate an assembly work and reduce an error of the assembly work, in addition to the simplification in configuration and the decrease in size. As a result, a user can facilitate the assembly work of the scanner 100 with a reduced size and reduce the error of the assembly work by employing the torque limiter 316.

In the scanner 100 according to the first embodiment, by connecting the power supply mechanism to the image capturing device moving mechanism 223 through the interlocking mechanism 315, it is possible to interlock the transmissive light source unit 321 with the image capturing device 217 by the use of the driving force of the single motor 222, thereby preventing the relative position in the sub scanning direction between the transmissive light source unit 321 and the image capturing device 217 from having difference.

Accordingly, according to the scanner 100, it is possible to prevent a decrease in precision for reading a document due to the difference in relative position in the sub scanning direction between the transmissive light source unit 321 and the image capturing device 217 at the time of movement and it is also possible to accomplish a decrease in size of the scanner 100 and a decrease in power consumption of the scanner 100.

Therefore, a user can obtain image data which are reproduced from an image of a document with high precision by the use of a small-sized image reading apparatus with reduced power consumption.

Since the transmissive light source unit 321 of the scanner 100 includes the LEDs 401, it is possible to read a document just after lighting the LEDs 401 and to stabilize the light intensity, compared with a case where a fluorescent tube is used instead of the LEDs 401.

Therefore, the scanner 100 can rapidly start the operation of reading a document and accomplish an enhancement in reading precision. As a result, a user can rapidly obtain image data with high precision.

According to the scanner 100, it is possible to suppress the power consumption and thus to suppress running cost, compared with a case where a fluorescent tube is used instead of the LEDs 401. Accordingly, a user can obtain image data with high precision by using the scanner 100 with reduced power consumption and running cost.

### Second Embodiment

Next, an image reading apparatus according to a second embodiment of the invention will be described in detail with reference to the accompanying drawings. Similarly to the first embodiment, the second embodiment relates to a scanner in which the image reading apparatus according to the invention is embodied. The scanner according to the second embodiment includes a torque limiter having a configuration different from that of the torque limiter 316 of the scanner 100 according to the first embodiment. In the second embodiment, differences from the first embodiment will be described, the same elements as the first embodiment are denoted by the same reference numerals, and description thereof is omitted.

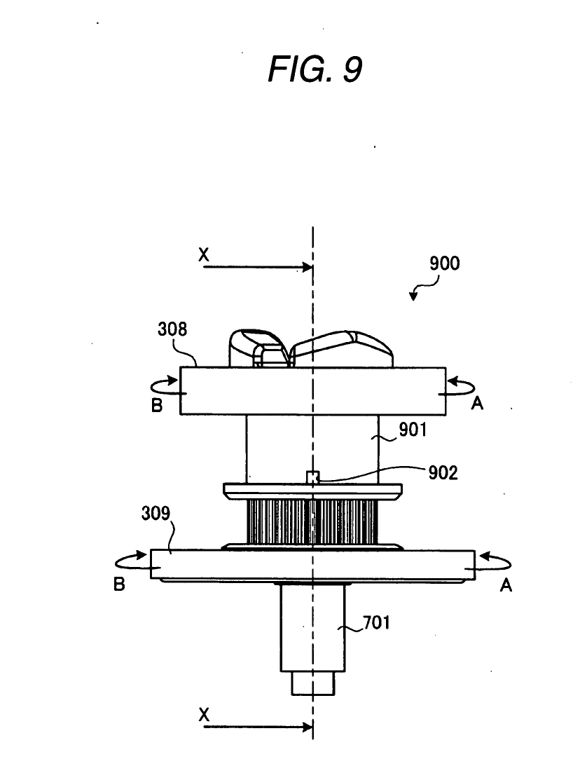

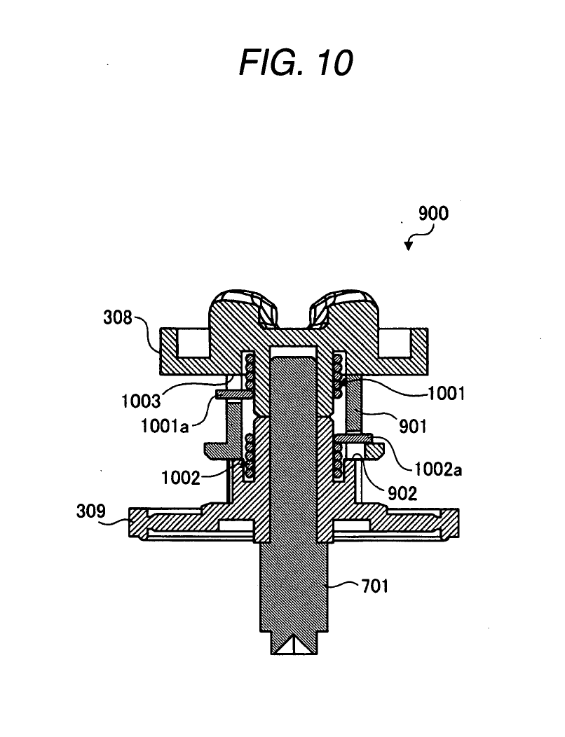

FIG. 9 is a side view illustrating an appearance of a torque limiter according to the second embodiment and FIG. 10 is a cross-sectional view taken along line X-X of FIG. 9. As shown in FIG. 9, the torque limiter 900 includes pulleys 308 and 309 disposed to be rotatable around a rotation shaft 701 which is centered on a virtual line of FIG. 9. The pulleys 308 and 309 are rotatable in any direction of a direction indicated by arrow A and a direction indicated by arrow B in FIG. 9.

As shown in FIG. 7, an O ring 901 as a rotation inducing member is disposed between the pulley 308 and the pulley 309 along the axial direction of the rotation shaft 701. The O ring 901 is provided with two openings for holding arms of two torsion coil springs (see FIG. 10). In FIG. 9, reference numeral 902 denotes an opening for holding the arm of one torsion coil spring of two torsion coil springs.

As shown in FIG. 10, the pulleys 308 and 309 in the torque limiter 900 are provided with two torsion coil springs 1001 and 1002, respectively. The torsion coil springs 1001 and 1002 nip and retain parts of the pulleys 308 and 309 along with the rotation shaft 701, respectively. The torsion coil springs 1001 and 1002 have the same winding directions. That is, the torsion coil springs 1001 and 1002 may be disposed in any one of the pulley 308 and the pulley 309.

The inner diameters of the torsion coil springs 1001 and 1002 are set equal to or less than the outer diameters of the pulleys 308 and 309 sandwiched by the torsion coil springs 1001 and 1002. Accordingly, the torsion coil springs 1001 and 1002 rotate with the rotations of the pulleys 308 and 309, respectively. The outer diameter of the torsion coil springs 1001 and 1002 are set smaller than the inner diameter of the O ring 901.

In the torsion coil springs 1001 and 1002, ends located on sides approaching each other in a state where they are disposed around the rotation shaft 701 are provided with arm portions 1001a and 1002a protruding in a direction which is apart from the rotation shaft 701, respectively. The arm portions 1001a and 1002a protrude from the openings 902 and 1003 formed in the O ring 901 to the outside of the O ring 901.

For example, when a torque for rotating the pulley 308 in a direction indicated by arrow A in FIG. 9 is supplied to the pulley 308 of the torque limiter 900, the torsion coil spring 1001 rotates in the direction of arrow A in FIG. 9 with the rotation of the pulley 308 in the direction of arrow A in FIG. 9. Since the arm portion 1001a of the torsion coil spring 1001 is held by the opening 1003, the O ring 901 rotates in the direction of arrow A in FIG. 9 with the rotation of the torsion coil spring 1001.

When the O ring 901 rotates, the torsion coil spring 1002 of which the arm portion 1002a is held by the opening 902 rotates in the direction of A in FIG. 9 with the rotation of the O ring 901. The pulley 309 rotates in the direction of arrow A in FIG. 9 with the rotation of the torsion coil spring 1002. Accordingly, the driving force of the motor 222 is supplied to the power supply mechanism through the image capturing device moving mechanism 223 and the interlocking mechanism 315.

The torsion coil spring 1002 rotating with the rotation of the pulley 308 is supplied with an urging force acting in a direction in which the inner diameter (outer diameter) of the torsion coil spring 1001 is enlarged from the O ring 901. When the torque supplied to the pulley 308 has a magnitude equal to or larger than a predetermined magnitude, the inner diameter (outer diameter) of the torsion coil spring 1002 is enlarged to reduce a frictional force acting between the torsion coil spring 1002 and the pulley 308, thereby causing a slide between the torsion coil spring 1002 and the pulley 308.

In this way, when a torque having a magnitude equal to or greater than a predetermined magnitude in the direction of arrow A in FIG. 9 is supplied to the pulley 308, the torque limiter 900 can prevent the torque having a magnitude equal to or greater than a predetermined magnitude from being supplied to the transmissive light source unit 321 and the power supply mechanism.

When a torque for rotating the pulley 308 in a direction indicated by arrow B in FIG. 9 is supplied to the pulley 308 of the torque limiter 900, the torsion coil spring 1001, the O ring 901, the torsion coil spring 1002, and the pulley 309 rotate in the direction of arrow B in FIG. 9 with the rotation of the pulley 308 in the direction of arrow B in FIG. 9.

The torsion coil spring 1001 rotating with the rotation of the O ring 901 is supplied with an urging force acting in a direction in which the inner diameter (outer diameter) of the torsion coil spring 1001 is enlarged from the O ring 901. When the torque supplied to the pulley 308 has a magnitude equal to or larger than a predetermined magnitude, the inner diameter (outer diameter) of the torsion coil spring 1001 is enlarged to reduce a frictional force acting between the torsion coil spring 1001 and the pulley 309, thereby causing a slide between the torsion coil spring 1001 and the pulley 309.

In this way, when a torque having a magnitude equal to or greater than a predetermined magnitude in the direction of arrow B in FIG. 9 is supplied to the pulley 308, the torque limiter 900 can prevent the torque having a magnitude equal to or greater than a predetermined magnitude from being supplied to the transmissive light source unit 321 and the power supply mechanism.

As described above, according to the scanner 100 of the second embodiment, since two torsion coil springs 1001 and 1002 of the torque limiter 900 have the same winding direction, it is possible to reduce the number of components. Accordingly, the torque limiter 900 can accomplish a decrease in error of an assembly work and a reduction in cost for manufacturing the apparatus.

Accordingly, a user can obtain a reduction in cost for manufacturing the scanner 100 with a decreased size and a decrease in error in the assembly work, by the use of the torque limiter 900.

### Third Embodiment

Next, an image reading apparatus according to a third embodiment of the invention will be described in detail with reference to the accompanying drawings. Similarly to the first embodiment, the third embodiment relates to a scanner in which the image reading apparatus according to the invention is embodied. The scanner 2100 according to the third embodiment includes an interlocking mechanism 451 having a configuration different from that of the interlocking mechanism 315 of the scanner 100 according to the first embodiment. In the third embodiment, differences from the first embodiment will be described, the same elements as the first embodiment are denoted by the same reference numerals, and description thereof is omitted.

Similarly to the scanner 100 according to the first embodiment, the scanner 2100 according to the third embodiment includes a main body unit 110 and a transmissive-document light source unit (hereinafter, referred to as “TPU unit”) 120 (see FIG. 1). The scanner 2100 includes a main body housing 210 10 constituting the outline of the main body unit 110 and a TPU housing 230 constituting the outline of the TPU unit 120 (see FIG. 2).

In the third embodiment, the power supply mechanism disposed in the TPU housing 230 is connected to the motor 222 to supply the driving force of the motor 222 to the transmissive light source unit when the protective mat 232 is detached from the TPU housing 230 (see FIG. 2). In this case, only when the protective mat 232 is detached from the TPU housing 230, the transmissive light source unit 421 moves in the sub scanning direction along with the scanner carriage 220 by means of the driving force supplied from the motor 222.

The transmissive light source unit 421 reciprocates between a home position which is set at an end position where the reading of a document is started and a return position which is set at a position where the document having been read is returned to the home position. The return position of the transmissive light source unit 421 is set to a position where mismatches in configuration of the elements for moving the transmissive light source unit 421 can be corrected by performing a positional matching operation to be described later. In the scanner 2100, a distance between a home position and a return position of the scanner carriage 220 is larger than a distance between the home position and the return position of the transmissive light source unit 421.

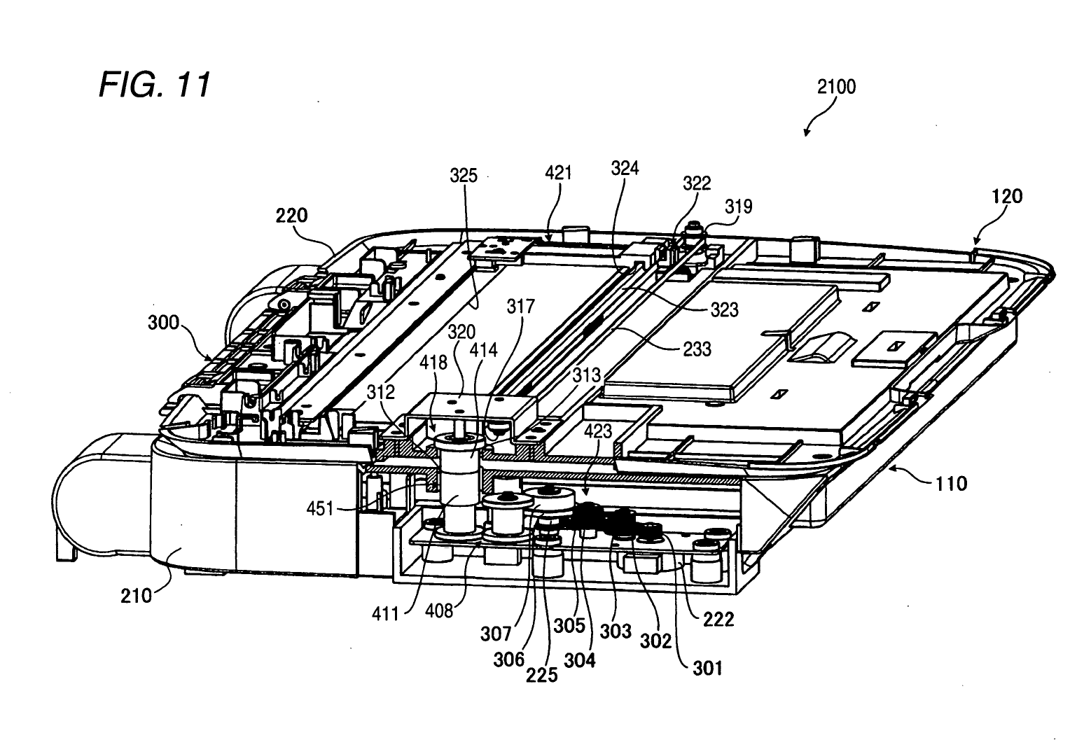

FIG. 11 is a partially sectional perspective view of the scanner 2100 according to the third embodiment. FIG. 11 shows a state where the upper TPU housing of the TPU housing 230 is removed and a part of the main body housing 210 is cut out. In FIG. 11, reference numeral 300 denotes a hinge portion for connecting the main body unit 110 and the TPU unit 120 to each other. Now, respective elements supplied with the driving force of the motor 222 are described with reference to FIG. 11.

As shown in FIG. 11, an image capturing device moving mechanism 423 disposed in the main body housing 210 includes a gear 301 fixed to a drive shaft of the motor 222 and a gear train 302 to 306 connected to the gear 301. A gear on which the drive belt 225 is suspended is disposed on a shaft which is a rotation axis of the gear 306.

The image capturing device moving mechanism 423 allows the drive belt 225 to rotate by supplying the driving force generated from the motor 222 to the drive belt 225 through the gears 301 to 306. Accordingly, the scanner carriage 220 connected to the drive belt 225 can move in the sub scanning direction.

The shaft as a rotation axis of the gear 306 is provided with a pulley 307 using the shaft as a rotation axis. The pulley 307 is connected to a magnetic member 411 constituting a part of the interlocking mechanism 451 through a plurality of pulley groups 408 which rotate with the rotation of the pulley 307. The magnetic member 411 rotates around an axis parallel to the axial direction of the pulley groups 408 by supplying the driving force of the motor 222 thereto through the pulley groups 408.

The magnetic member 411 is disposed to face the magnetic member 414 disposed on the TPU unit 120 with the openings 312 and 313 opened toward the TPU unit 120 therebetween on the top surface of the main body housing 210. The magnetic member 411 and the magnetic member 414 are separably connected to each other. Here, the interlocking mechanism 451 is constituted by the pulley 307, the pulley groups 408, the magnetic member 411, the openings 312 and 313, and the magnetic member 414. The magnetic member 414 is disposed to be rotatable around the axis parallel to the axial direction of the magnetic member 411.

Both magnetic members 411 and 414 constituting the interlocking mechanism 451 may have a magnetic force of attracting each other or at least one thereof may have a magnetic force of attracting the other. When one of the magnetic members 411 and 414 has a magnetic force, the other is formed of a material such as iron having a feature attracted by a magnetic force.

The TPU housing 230 is provided with a pulley group 418 connecting the magnetic member 414 to one gear 317 of the pair of gears on which the drive belt 233 is suspended. The other gear 319 of the pair of gears rotates with the rotation of the drive belt 233. The gear 317 and the gear 319 are opposed to each other in the sub scanning direction.

The interlocking mechanism 451 has a torque limiter function of not supplying the driving force having a magnitude larger than a predetermined magnitude to the pulley group 418 by allowing the magnetic member 411 and the magnetic member 414 to slide on each other when the torque supplied from the image capturing device moving mechanism 423 is larger than a predetermined value. Here, the torque having the predetermined magnitude is a torque necessary to move the transmissive light source unit.

Thanks to the torque limiter function of the interlocking mechanism 451, it is possible to prevent the elements associated with the movement of the transmissive light source unit from damaging, such as the transmissive light source unit, the pulley group 418, and the pair of gears on which the drive belt 233 is suspended.

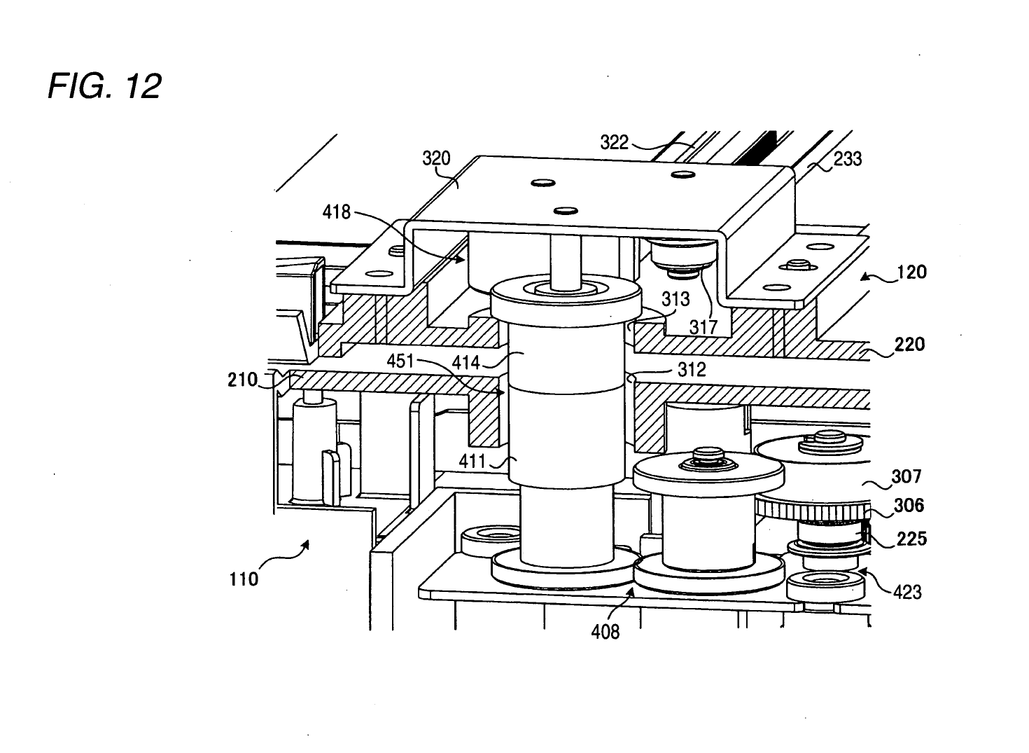

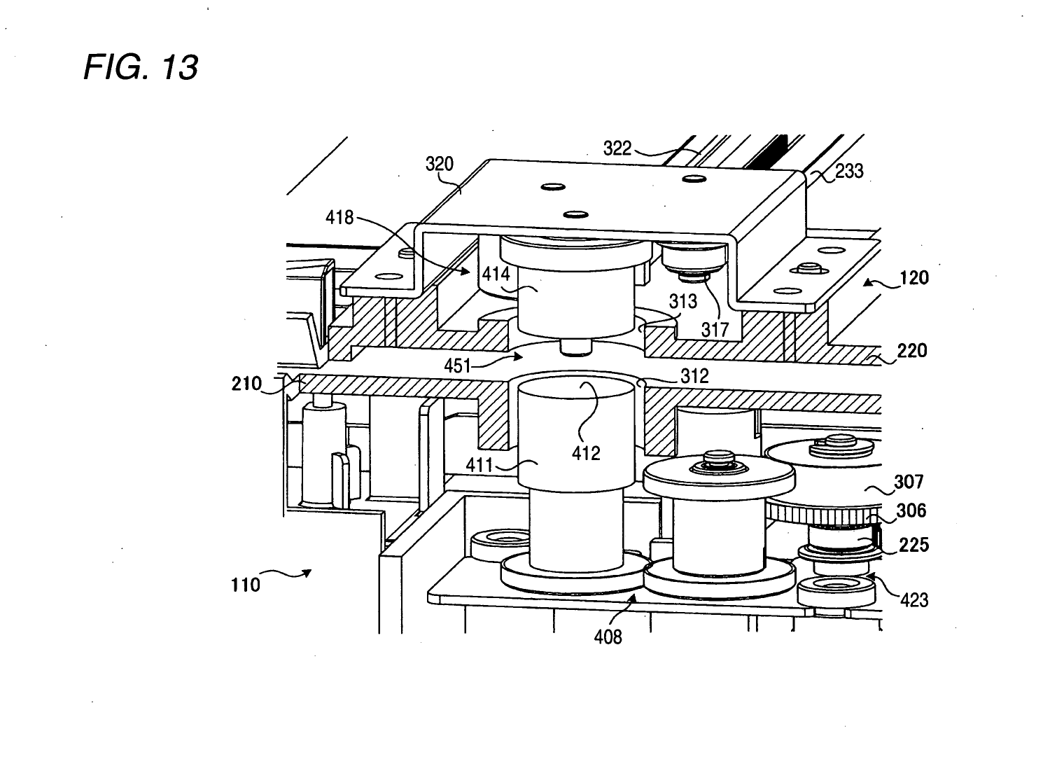

In FIG. 11, reference numeral 320 denotes a stay for supporting shafts of the magnetic member 414, the pulleys of the pulley group 418, the gear 317, and the like. The magnetic member 414 is disposed to be detachable from the stay 320 (see FIGS. 12 and 13). As a result, the magnetic member 411 and the magnetic member 414 can be allowed to detachably engage with each other.

In FIG. 11, reference numeral 421 denotes the transmissive light source unit. The transmissive light source unit 421 is connected to the drive belt 233 at a fixing portion 322 disposed in the transmissive light source unit 421. Accordingly, the transmissive light source unit 421 moves in the sub scanning direction with the rotation of the drive belt 233.

The TPU housing 230 is provided with a guide rail 323 extending in the sub scanning direction at a position which is a side of the drive belt 233 and which is overlapped with the movement trace of the transmissive light source unit 421. The guide rail 323 is inserted into a groove 324 disposed at a position opposed to the guide rail 323 in the transmissive light source unit 421. Accordingly, the transmissive light source unit 421 can stably move in the sub scanning direction.

The light emitted from the transmissive light source unit 421 is guided to the document table glass 212 through an opening 325 formed in the TPU housing 230. The opening 325 is disposed to cover a film reading range of a region which can be irradiated by the transmissive light source unit 421.

In the third embodiment, similarly to the transmissive light source unit 318 according to the first embodiment, the transmissive light source unit 421 includes LEDs 401 and a light guide plate 402 for guiding the light emitted from the LEDs 401 (see FIG. 4).

The light guided by the light guide plate 402 is applied to the document table glass 212 from the opening 406 disposed in the support frame 405 through the prism sheet 403 and the diffusion sheet 404. The light guided by the light guide plate 402 can be applied to a larger area by using the prism sheet 403 and the diffusion sheet 404.

In the transmissive light source unit 421, a reflecting plate 407 for reflecting the light guided by the light guide plate 402 toward the opening 406 is disposed on a side opposite to the opening 406 with the light guide plate 402 interposed therebetween. By disposing the reflecting plate 407, the light guided by the light guide plate 402 can be efficiently applied to the document table glass 212.

The fixing portion 322 is disposed on a side of the support frame 405 and is opened upwardly so as to nip the drive belt 233 from the document table glass 212 side.

FIG. 12 is an enlarged perspective view (first) of the interlocking mechanism 451 and FIG. 13 is an enlarged perspective view (second) of the interlocking mechanism 451. FIG. 12 shows a state where the magnetic member 411 and the magnetic member 414 are connected to each other by a magnetic force. FIG. 13 shows a state where the magnetic member 411 and the magnetic member 414 are separated from each other.

As can be seen from FIGS. 12 and 13, the magnetic member 414 of the interlocking mechanism 451 is connected to the magnetic member 411 when it is separated from the stay 320, and is separated from the magnetic member 411 when it is located in the vicinity of the stay 320. The opposed surfaces of the magnetic members 411 and 414 are planar (see reference numeral 412). Accordingly, it is possible to secure a wide plane on which the attraction force acts, thereby reliably connecting the magnetic member 411 to the magnetic member 414.

When an image of a film is read by the scanner 2100 having the above-mentioned configuration, a user places a film holder 240 on the document table glass 212 and places the film at a predetermined position guided by the film holder 240. The user removes the protective mat 232 from the TPU housing 230 before or after placing the film.

Subsequently, the TPU unit 120 is opposed to the main body unit 110 (see FIGS. 1 and 2). Accordingly, the magnetic member 411 and the magnetic member 414 of the interlocking mechanism 451 engage with each other, thereby connecting the transmissive light source unit 421 to the image capturing device moving mechanism 423.

Thereafter, the user inputs an instruction for reading an image of the film. The instruction may be input through the operation panel of the scanner 2100 or may be input through the external device such as a personal computer.

When the instruction for reading the image of the film is input, the scanner 2100 drives the motor 222 and detects the intensity of light received by the image capturing device 217 while moving the scanner carriage 220 and the transmissive light source unit 421 in the sub scanning direction. The scanner creates image data based on the detected intensity of light.

Before creating the image data, the scanner 2100 may acquire a variety of reference data serving as a reference of a black color or a white color in the image data and may perform a shading correction on the image data on the basis of the acquired reference data. The acquisition of the reference data and the shading correction using the acquired reference data are not described herein.

Before creating image data, the scanner 2100 may perform a positional matching process of correcting the relative position between the transmissive light source unit 421 and the image capturing device 217. At the time of performing the positional matching process, the scanner carriage 220 is allowed to move to the return position, for example, by driving the motor 222 in a state where the power supply mechanism disposed in the TPU unit 120 and the motor 222 are interlocked with each other.

As described above, in the scanner 2100, a distance between the home position and the return position of the scanner carriage 220 is set larger than a distance between the home position and the return position of the transmissive light source unit 421. Accordingly, the transmissive light source unit 421 reaches the return position of the transmissive light source unit 421 while the scanner carriage 220 moves to the return position.

When the motor 22 is further driven in this state, the magnetic member 411 and the magnetic member 414 having the torque limiter function in the interlocking mechanism 451 slide over each other and thus only the scanner carriage 220 moves to the return position in a state where the transmissive light source unit 421 is located at the return position.

After the scanner carriage 220 is allowed to move to the return position, the scanner carriage 220 and the transmissive light source unit 421 are allowed to move the home position from the return position by further driving the motor 222. At the time point when the scanner carriage 220 moves to the home position, the positional matching process between the transmissive light source unit 421 and the image capturing device 217 is completed.

It can be detected by disposing a sensor at a predetermined position that the scanner carriage 220 moves to the return position or the home position. The sensor for detecting the position of the scanner carriage 220 and the technique of detecting the position of the scanner carriage 220 using the sensor are not described.

When the transmissive light source unit 421 reaches the return position of the transmissive light source unit 421 before the scanner carriage 220 reaches the return position of the scanner carriage 220, the magnetic member 411 and the magnetic member 414 having the torque limiter function in the interlocking mechanism 451 slide over each other and thus only the scanner carriage 220 moves to the return position in a state where the transmissive light source unit 421 is located at the return position.

As described above, in the scanner 2100 according to the third embodiment, the scanner carriage 220 mounted with the reflective light source 215 suitable for reading a reflective document and the transmissive light source unit 421 suitable for reading a transmissive document can be made to move by the single image capturing device moving mechanism 423.

Accordingly, even when the scanner 2100 has such a configuration that the reflective light source 215 and the transmissive light source 421 are selectively used depending on the types of a document, it is possible to suppress an increase in manufacturing cost due to the selective use of the reflective light source 215 and the transmissive light source unit 421 depending on the types of a document, by allowing the scanner carriage 220 and the transmissive light source unit 421 to move by the use of the single image capturing device moving mechanism 423.

Accordingly, a user can obtain image data which are reproduced from an image of a document with high precision, by the use of the scanner 2100 with reduced manufacturing cost.

In the scanner 2100 according to the third embodiment, a slide occurs in the interlocking mechanism 451 when a torque larger than a predetermined magnitude is supplied thereto. Accordingly, it is possible to interlock the image capturing device moving mechanism 423 with the light source moving mechanism 421 without damaging the elements associated with the movement of the transmissive light source unit 421. As a result, a user can obtain image data with high precision by interlocking the image capturing device moving mechanism 423 with the light source moving mechanism 421 without feeling a particular burden.

In the third embodiment, when a torque larger than a predetermined value is supplied to the elements associated with the movement of the transmissive light source unit 421 from the image capturing device moving mechanism 423, a slide is allowed to occur between the magnetic member 411 and the magnetic member 414 in the interlocking mechanism 451, thereby performing the torque limiter function. However, the performing of the torque limiter function is not limited to the use of the magnetic force.

Although not shown in the figures, for example, a pair of gears may be provided instead of the magnetic member 411 and the magnetic member 414. In this case, when a torque larger than a predetermined value is supplied to the elements associated with the movement of the transmissive light source unit 421 from the image capturing device moving mechanism 423, the torque limiter function may be performed by idling one of the pair of gears. The technique of idling a gear when a torque larger than a predetermined value is supplied is not described herein.

In the scanner 2100 according to the third embodiment, it is possible to suppress the power consumption to the minimum by moving the transmissive light source unit 421 only at the time of reading a film. Accordingly, a user can obtain image data which are reproduced from an image of a document with high precision by the use of the scanner with reduced power consumption, regardless of the type of a document.

In the scanner 2100 according to the third embodiment, it is possible to interlock the image capturing device moving mechanism 423 with the transmissive light source unit 421, only when the TPU unit 120 is opposed to the document table glass 212. Accordingly, a user can easily read a film without feeling uncomfortable or stress, by performing only the same operation as opposing the TPU unit 120 to the document table glass 212 so as to place a film on the document table glass 212.

According to the scanner 2100 of the third embodiment, since the motor 222 is disposed in the main body housing 210, it is possible to reduce the weight of the TPU unit 120. Accordingly, the scanner 2100 can reduce a user's burden accompanied with the rotation of the TPU unit 120. As a result, a user can rotate the TPU unit 120 with a small burden.

Although the scanner 2100 in which the motor 222 is disposed in the main body housing 210 has been described in the third embodiment, the motor 222 may be disposed in the TPU unit 120. In this case, in the scanner 2100, it is possible to simplify the image capturing device moving mechanism 423 in the main body housing 210.

Accordingly, according to the scanner 2100, it is possible to prevent a damage of the scanner 2100 due to the heat radiation resulting from the excessive density in the main body housing 210. Accordingly, a user can use safely a small-sized multi-function machine with reduced power consumption and can obtain image data with high precision by only attaching and detaching the TPU unit 120 to and from the document table glass 212.

According to the scanner 2100 of the third embodiment, it is possible to read a document just after lighting the LEDs 401 because the LEDs 401 are used in the transmissive light source unit 421. Therefore, the scanner 2100 can rapidly start the operation of reading a document. As a result, a user can rapidly obtain image data which are reproduced from an image of a document with high precision, regardless of the types of the document.

When the LEDs 401 are used, a noise is less generated in the image data than that in the case where the fluorescent tube is used. Accordingly, a user can rapidly obtain image data which are reproduced from an image of a document with high precision, regardless of the type of the document. In the scanner 2100, it is possible to suppress the power consumption by using the LEDs 401, compared with a case where the fluorescent tube is used. As a result, the user can rapidly obtain image data which are reproduced from an image of a document with high precision while suppressing the running cost.

Regardless of the type of a document, the scanner 2100 according to the third embodiment can output the image data, in which an image of a document is reproduced with high precision, to an external device such as a personal computer. Accordingly, a user can use the image data, in which an image of a document is reproduced with high precision, with the external device such as a personal computer regardless of the type of the document.

### Fourth Embodiment

A multi-function machine according to a fourth embodiment of the invention will be described in detail with reference to the accompanying drawings. The fourth embodiment of the invention relates to a multi-function machine. In the fourth embodiment, the same elements as the first to third embodiments are denoted by the same reference numerals and description thereof is omitted.

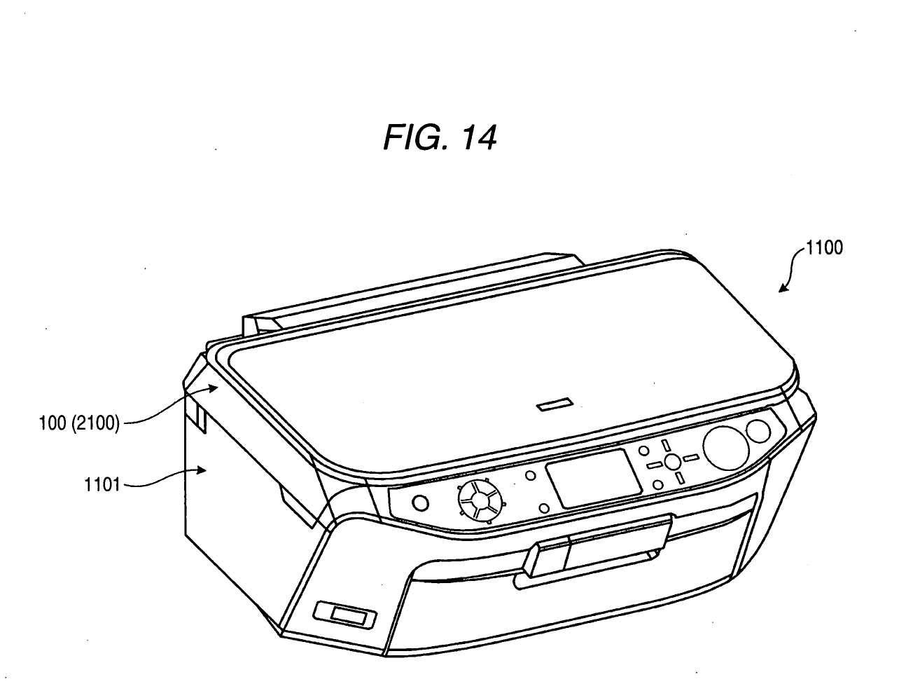

FIG. 14 is a perspective view illustrating an appearance of a multi-function machine according to the fourth embodiment of the invention. The multi-function machine 1100 according to the fourth embodiment includes the scanner 100 or the scanner 2100 described in the first to third embodiments and a printer 1101 as an image forming apparatus for forming on a recording medium an image corresponding to intensity of light incident on the image capturing device 217 of the scanner 100 or the scanner 2100.

The scanner 100 or the scanner 2100 and the printer 1101 are connected to each other so as to communicate with each other through a communication I/F not shown. The scanner 100 or the scanner 2100 outputs image data corresponding to the intensity of light incident on the image capturing device 217 to the printer 1101.

The printer 1101 includes a printer engine for forming an image on a recording medium such as a sheet of paper. A variety of methods such as an ink jet method, an electrostatic transfer method, and a sublimation transfer method can be used as the image forming method of the printer engine.

In the multi-function machine 1100 having the above-mentioned configuration, the printer 1101 forms an image on a recording medium such as a sheet of paper on the basis of the image data output from the scanner 100 or the scanner 2100.

According to the multi-function machine 1100, it is possible to reduce the power consumption in reading a document and reduce the size of the multi-function machine 1100 by using the image data read by the scanner 100 or the scanner 2100 and it is also possible to form on a recording medium such as a sheet of paper an image based on the image data, which are reproduced from the image of the document with high precision, regardless of the types of the document. Accordingly, a user can obtain a recording medium having an image formed thereon based on the image data with high precision regardless of the type of the document, by the use of a small-sized multi-function machine with reduced power consumption.

What is claimed is:

1. A torque limiter comprising:
a rotation shaft, a location of which is fixed;
two rotating members, rotatable around an axis of the rotation shaft;
two torsion coil springs which are wound on the rotating members, respectively; and
a rotation inducing member, adapted to hold one end of each of the two torsion coil springs.

2. The torque limiter according to claim 1, wherein
winding directions of the two torsion coil springs are different from each other.

3. The torque limiter according to claim 1, wherein
winding directions of the two torsion coil springs are identical with each other.

4. An image reading apparatus which has a light source disposed in a cover member detachably attached to a document table for holding a document and an image capturing device disposed opposite to the light source with the document table interposed therebetween, the image reading apparatus comprising:
a light source moving mechanism, disposed in the cover member and operable to move the light source in a scanning direction;
an image capturing device moving mechanism, operable to move the image capturing device in the scanning direction;
a driving source, operable to supply a driving force to the image capturing device moving mechanism; and
an interlocking mechanism, operable to interlock the image capturing device moving mechanism with the light source moving mechanism through the torque limiter according to claim 1.

5. An image reading apparatus which has a light source disposed in a cover member detachably attached to a document table for holding a document and an image capturing device disposed opposite to the light source with the document table interposed therebetween, the image reading apparatus comprising:
a light source moving mechanism, disposed in the cover member and operable to move the light source in a scanning direction;
an image capturing device moving mechanism, operable to move the image capturing device in the scanning direction;
a driving source, operable to supply a driving force to the image capturing device moving mechanism; and
an interlocking mechanism, operable to interlock the image capturing device moving mechanism with the light source moving mechanism by allowing an attractive force to act between the light source moving mechanism and the image capturing device moving mechanism depending on a position of the cover member relative to the document table.

6. The image reading apparatus according to claim 5, wherein
the interlocking mechanism applies an attractive force having a magnitude enough to cause a slide between the light source moving mechanism and the image capturing device moving mechanism when a torque having a predetermined value or more is supplied to the interlocking mechanism.

7. The image reading apparatus according to claim 5, further comprising:
a hinge portion, rotatably connecting one end of the cover member to a main body housing for housing the image capturing device, wherein
the cover member rotates about the main body housing through the hinge portion so as to be attached to and detached from the document table.

8. The image reading apparatus according to claim 7, wherein
the driving source is disposed in the main body housing.

9. The image reading apparatus according to claim 5, wherein
the driving source is disposed in the cover member.

10. The image reading apparatus according to claim 4, wherein
the light source includes an LED.

11. A multi-function machine comprising:
the image reading apparatus according to claim 4; and
an image forming apparatus, operable to form on a recording medium an image corresponding to intensity of light incident on the image capturing device of the image reading apparatus.
